(19) United States
(12) Patent Application Publication
(10) Pub. No.: US 2026/0073616 A1
(43) Pub. Date: Mar. 12, 2026

(54) 3D RAY-WORLD INTERSECTION FOR XR DEVICES

(71) Applicant: Snap Inc., Santa Monica, CA (US)

(72) Inventors: Tobias Maier, Vienna (AT); Olha Borys, Vienna (AT); Jakob Zillner, Absdorf (AT); Feliks Hibraj, Vienna (AT); Dario Fontanel, Vienna (AT)

(21) Appl. No.: 18/827,523

(22) Filed: Sep. 6, 2024

(51) Int. Cl. G06T 15/06; G06T 19/00

(52) U.S. Cl. CPC G06T 15/06; G06T 19/006; G06T 2210/21

(57) ABSTRACT

A system for world-ray intersection modeling has a memory storing instructions that, when executed by a processor, configure the system to perform operations. Video data comprising a video frame is obtained. Depth map data is obtained, comprising, for each pixel of a plurality of pixels of the video frame, a depth value of an object visible at a pixel location of the pixel. Ray data is obtained, representative of a ray in three-dimensional space. The depth map data and the ray data are processed to generate intersection data comprising a three dimensional location of an intersection of the ray with the object visible at the pixel location. The intersection can be determined using a voxel representation of the depth map data or by stepwise traversal of the ray. A trajectory defined by multiple intersections over time can be smoothed to present virtual content moving in a realistic fashion.

### BACKGROUND

A head-worn device may be implemented with a transparent or semi-transparent display through which a user of the device can view the surrounding environment. Such devices enable a user to see through the transparent or semi-transparent display to view the surrounding environment, and to also see objects or other content (e.g., virtual objects such as 3D renderings, images, video, text, and so forth) that are generated for display to appear as a part of, and/or overlaid upon, the surrounding environment (referred to collectively as “virtual content”). In some cases, the display is opaque, and the user is presented with a visual representation of the real-world environment as captured by cameras on the device; this approach can also be implemented by mobile devices such as smart phones. Each of these approaches is typically referred to as “extended reality” or “XR”, which encompasses techniques such as augmented reality (AR), virtual reality (VR), and mixed reality (MR). Each of these technologies combines aspects of the physical world with virtual content presented to a user. Devices using a transparent display are referred to as “optical see-through” XR, while devices using camera output to display the real-world environment are referred to as “video see-through” XR. Both types of device can have cameras to sense the user's environment.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram of an XR device configured to perform ray-world intersection, according to some examples.

FIG. 2 is a block diagram of the ray-world intersection system of the XR device of FIG. 1, according to some examples.

FIG. 3 is a schematic diagram showing stages of data processing performed by the ray-world intersection system of FIG. 2, according to some examples.

FIG. 4 is a flowchart showing operations of a method for determining an intersection of a ray with an object in a real-world scene, according to some examples.

FIG. 5 is a flowchart showing operations of a first example of the ray intersection operation of the method of FIG. 4, according to some examples.

FIG. 6 is a flowchart showing operations of a second example of the ray intersection operation of the method of FIG. 4, according to some examples.

FIG. 7 illustrates an example environment in which a user's finger is used as a ray casting reference to cast two successive rays into the environment to generate ray-world intersection data, according to some examples.

FIG. 8A illustrates the example environment of FIG. 7 in which multiple rays are cast from the user's finger to cast multiple rays and detect multiple intersections defining a trajectory, according to some examples.

FIG. 8B illustrates the example environment and trajectory of FIG. 8A in which the trajectory has been smoothed, according to some examples.

FIG. 9A illustrates the example environment of FIG. 7 in which the second ray intersection operation has failed, according to some examples.

FIG. 9B illustrates the example environment of FIG. 9A in which a plane is extended from the first intersection to generate second intersection data for the failed intersection operation, according to some examples.

FIG. 10 is a flowchart showing operations of a method for presenting virtual content based on multiple ray-world intersections, according to some examples.

FIG. 11 is a diagrammatic representation of a machine in the form of a computer system within which a set of instructions may be executed to cause the machine to perform any one or more of the methodologies discussed herein, according to some examples.

FIG. 12 is a block diagram showing a software architecture within which examples may be implemented.

### DETAILED DESCRIPTION

Generating a 3D representation of a user's environment is a technical problem that has been approached using a number of different techniques, including various machine vision techniques that use video data from cameras to infer 3D features of the environment. However, many of these techniques are computationally expensive and/or require specialized sensors, making them inappropriate for execution by a small mobile device such as smart glasses generating 3D data in real time.

XR devices, such as head-mounted XR devices, rely on 3D data about the user's environment in order to enhance the presentation of virtual content. Ideally, virtual objects should be presented on the user's display such that their location and orientation is consistent with the locations and orientations of the real-world objects with which they appear to interact. Thus, for example, the perceived realism of a virtual object may be enhanced by placing and orienting it such that it appears to abut a surface of a real-world object in the same way that another real-world object would. Similarly, a virtual object should interact with real-world objects in a realistic way, such as collision and occlusion interactions.

In some cases, only a single point in the user's 3D environment needs to be modeled in order to model an interaction. For example, a virtual object can be positioned in virtual 3D space based on the 3D location and/or surface orientation of a single point on a surface of an object in the user's environment, or the virtual object can collide with a real-world object at a single point on a surface, also referred to as ray-world intersection or hit testing. These interactions can be modeled by casting a ray in 3D space and modeling its intersection with a real-world object, also referred to as ray-world intersection or hit testing.

Existing ray-casting approaches, in addition to the computational limitations described above, tend to have other limitations, such as being limited to rays cast from the point of view of the camera.

Accordingly, it would be beneficial to provide computationally efficient techniques for modeling the intersection or collision of rays cast into a 3D real-world environment. Examples described herein address one or more of the technical problems described above. In some examples, sparse depth data generated by other subsystems of an XR device, such as hand tracking subsystems and/or VIO subsystems, are leveraged to enrich the video data from one or more cameras in order to generate 3D data. In some examples, a lightweight trained machine learning model, such as a deep neural network, is used to process the video data and the sparse depth data to generate a depth map of one or more video frames of the video data. After the depth map is created, the intersection or collision of the ray with the real-world environment can be modeled by one of several different techniques. In some examples, the ray is traversed stepwise from its origin, with collision or intersection being determined when a given step encounters a point of a real-world object in close proximity to the point along the ray corresponding to the step. In some examples, a voxel (volumetric pixel) representation of the depth map is created, and existing mathematical techniques from voxel modeling are used to compute the intersection of the ray with a voxel corresponding to a point on a real-world object. In some examples, the intersection data generated by the ray casting operation includes not only a 3D location of the intersection, but also a surface normal or orientation of the real-world object's surface at the point of intersection; the surface normal can be determined based on the locations of neighboring real-world 3D points on the object's surface.

By leveraging existing sparse depth data (e.g., VIO data and/or hand tracking data) in addition to video data and performing computationally lightweight depth map generation and ray casting, some examples described herein provide computationally efficient ray-world intersection modeling suitable for real-time execution by a mobile device on each video frame of a sequence of video frames (such as every video frame of a video stream captured by a camera, or some periodic sample of the video frames of the video stream, such as one in every six video frames of a 24 frames-per-second video stream).

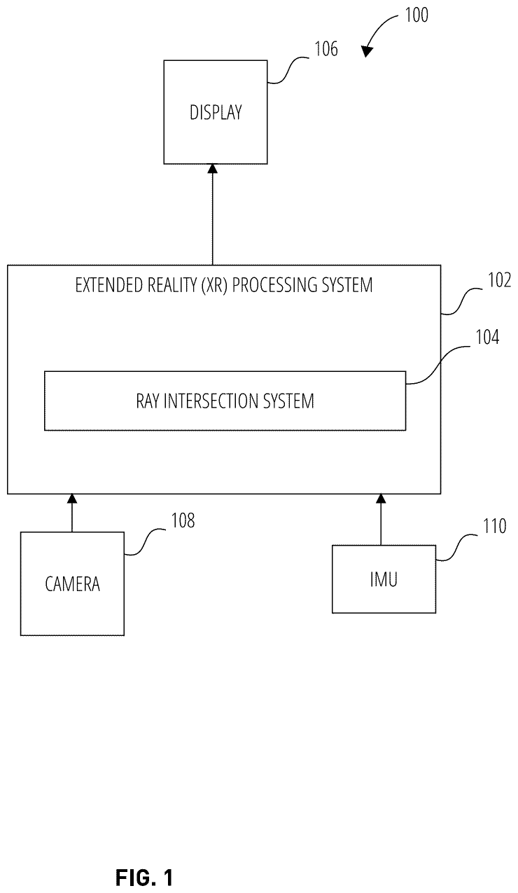

FIG. 1 shows a block diagram of an XR device 100 configured to perform ray-world intersection modeling. The XR device 100 provides functionality to augment the real-world environment of a user. For example, the XR device 100 allows for a user to view real-world objects in the user's physical environment along with virtual content to augment the user's environment. In some examples, the virtual content provides the user with data describing the user's surrounding physical environment, such as presenting data describing nearby businesses, providing directions, displaying weather information, and the like.

The virtual content can be presented to the user based on the distance and orientation of the physical objects in the user's real-world environment, as described above.

In some embodiments, the XR device 100 is a mobile device, such as a smartphone or tablet, that presents real-time images of the user's physical environment along with virtual content. Alternatively, the XR device 100 is a wearable device, such as a helmet or glasses, that allows for presentation of virtual content in the line of sight of the user, thereby allowing the user to view both the virtual content and the real-world environment simultaneously.

As shown, the XR device 100 includes at least one camera 108, an inertial measurement unit (IMU) 110, and a display 106 connected to and configured to communicate with an XR processing system 102 via communication links. The communication links may be either physical or wireless. For example, the communication links can include physical wires or cables connecting the camera 108, IMU 110, and display 106 to the XR processing system 102. Alternatively, the communication links can be wireless links facilitated through use of a wireless communication protocol, such as Bluetooth™.

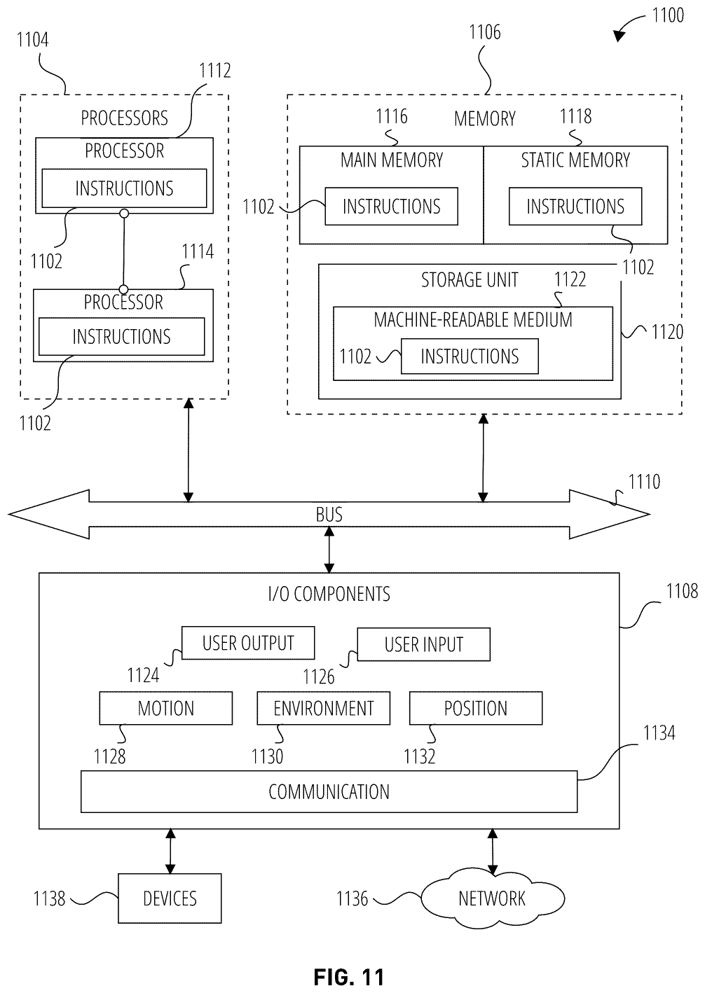

Each of the camera 108, IMU 110, display 106, and XR processing system 102 can include one or more devices capable of network communication with other devices. For example, each device can include some or all of the features, components, and peripherals of the machine 1100 shown in FIG. 11.

The camera 108, and any other cameras included in the XR device 100, may be any type of sensor capable of capturing image data. For example, the camera 108 may be a color camera, configured to capture images and/or video. The images captured by the camera 108 are provided to the XR processing system 102 via the communication links. The images captured by the camera 108 may be referred to herein as the output of the camera 108, and may be encoded as video data including one or more video frames, such as a temporal sequence of video frames.

In some examples, the 100 includes two or more cameras that allow for use of stereo vison. The camera 108 and another camera can be displaced at a known distance from one another to capture overlapping images depicting two differing views of the real-world environment from two different vantage points. The orientation of the cameras within, or relative to, the XR device 100 can be calibrated to provide a known image transformation between the two cameras. The image transformation is a function that maps the location of a pixel in one image to the corresponding location of the pixel in the corresponding image. However, it will be appreciated that some examples described herein may require only a single camera 108.

In some examples, one or more cameras of the XR device 100 are used to track a user's hands. The hand tracking cameras may be oriented differently from the camera 108: for example, the camera 108 may be front-facing on a head mounted XR device 100, but the hand tracking cameras may be oriented to face downward in order to capture hand movements performed below the center of the user's field of vision. In some examples, the hand tracking cameras can be infrared cameras, or they can be replaced or supplemented by depth sensors or other sensors suitable for tracking hand movements.

The display 106 may be any of a variety of types of displays capable of presenting virtual content. For example, the display 106 may be a monitor or screen upon which virtual content may be presented simultaneously with images of the user's physical environment. Alternatively, the display 106 may be a transparent display that allows the user to view virtual content being presented by the display 106 in conjunction with real world objects that are present in the user's line of sight through the display 106.

The XR processing system 102 is configured to provide XR functionality to augment the real-world environment of the user. For example, the XR processing system 102 generates and causes presentation of virtual content on the display 106 based on the physical location of the surrounding real-world objects to augment the real-world environment of the user. The XR processing system 102 presents the virtual content on the display 106 in a manner to create the perception that the virtual content is interacting realistically with a physical object. For example, the XR processing system 102 may generate the virtual content based on a determined surface plane that indicates a location (e.g., defined by a depth and a direction) and surface normal of a surface of a physical object. The depth indicates the distance of the real-world object from the XR device 100. The direction indicates a direction relative to the XR device 100, e.g., as indicated by a pixel coordinate of the image captured by the camera 108, which corresponds to a known angular displacement from a central optical axis of the camera 108. The surface normal is a vector that is perpendicular to the surface of the real-world object at a particular point. The XR processing system 102 can use the surface normal to generate and cause presentation of the virtual content to create the perception that the virtual content is interacting with (e.g., located and oriented on, colliding with, occluding or occluded by) the surface of the real-world object.

The XR processing system 102 includes a ray intersection system 104. The ray intersection system 104 casts a ray into a data representation of the 3D real-world environment as viewed by the camera 108, determines a pixel location within the image captured by the camera 108 of the intersection of the ray with a surface of an object visible in the image, and in some cases determines a surface normal of the surface of the real-world object at the intersection.

The ray intersection system 104 then provides intersection data defining the pixel location of the intersection, and in some cases the surface normal at the intersection, to the XR processing system 102. In turn, the XR processing system 102 uses the intersection data to generate and present virtual content that appears to interact realistically with the real-world environment. In some examples, the XR processing system 102 uses the intersection data to present virtual content with a location and/or an orientation based on the intersection data. In some examples, the XR processing system 102 uses the intersection data to present virtual content as being at least partially occluded based on the intersection data. It will be appreciated that the intersection data can also be used by other functions, modules, software applications, or processes of the XR device 100 or of other devices to perform operations that rely on 3D information about the user's environment.

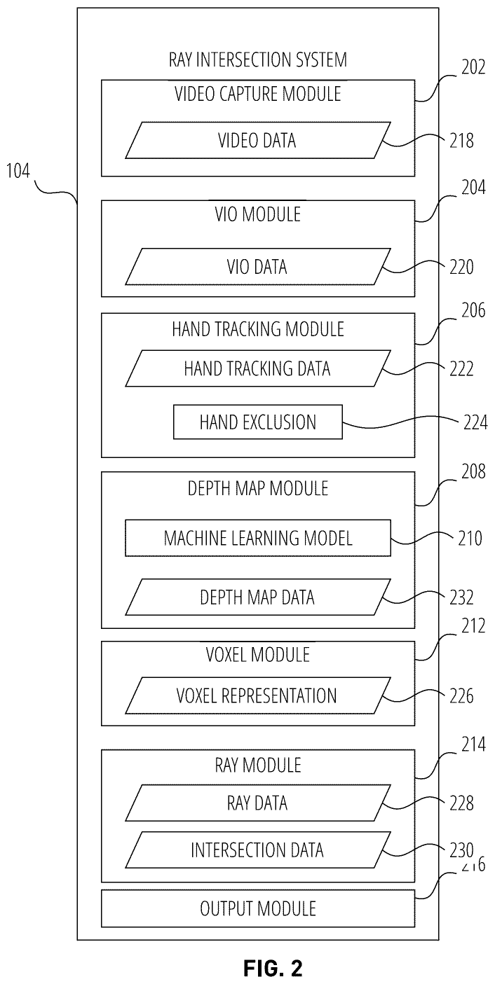

FIG. 2 is a block diagram of an example of the ray intersection system 104 of the XR device 100. It will be appreciated that various additional functional components may be supported by the ray intersection system 104 to facilitate additional functionality that is not specifically described herein. The various functional modules depicted in FIG. 2 may reside on a single computing device or may be distributed across several computing devices in various arrangements such as those used in cloud-based architectures. However, in some examples, the ray intersection system 104 is implemented within software executing on one or more processors of a single mobile device, such as a head-mounted XR device, in order to perform real-time ray-world intersection modeling for a stream of video frames generated by a camera of the XR device, based at least in part on VIO data and/or hand tracking data generated by one or more cameras and/or an IMU of the device.

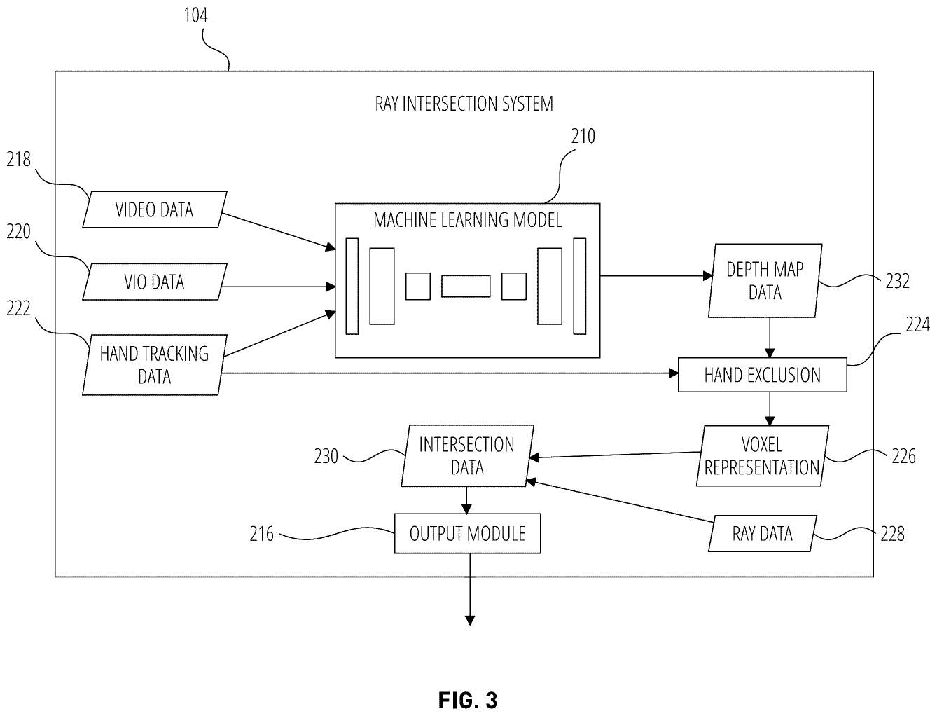

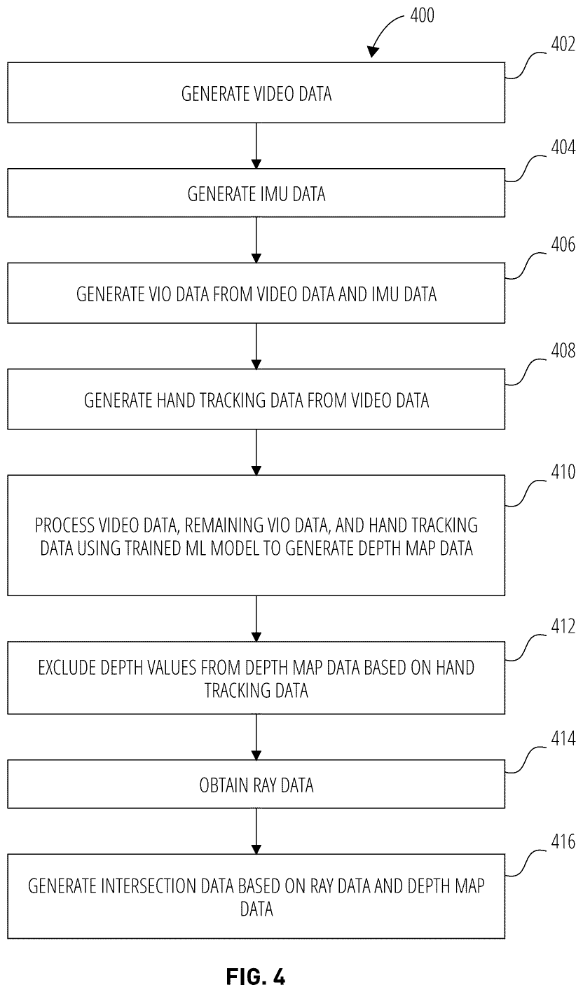

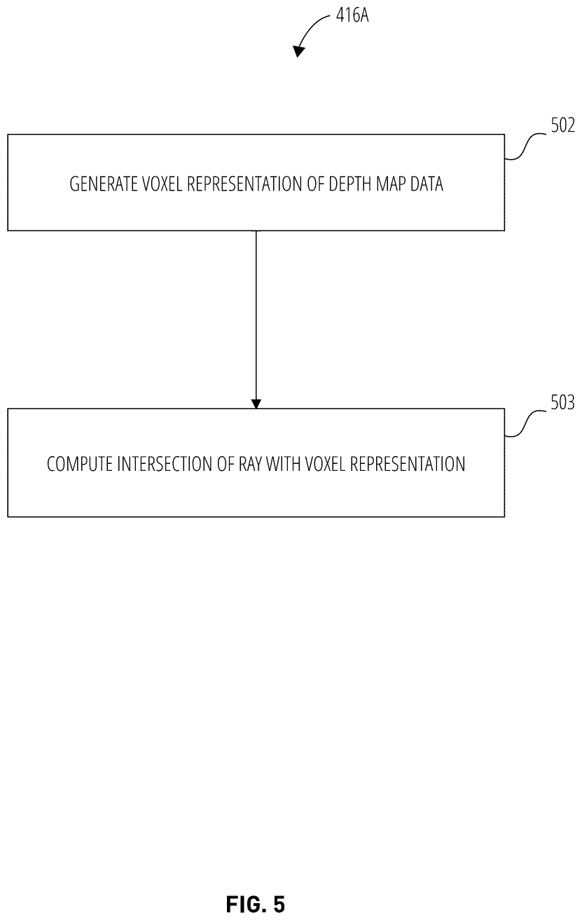

As shown, the ray intersection system 104 includes a video capture module 202, a VIO module 204, a hand tracking module 206, a depth map module 208 (which includes a trained machine learning (ML) model 210), a voxel module 212, and a ray module 214, and an output module 216. The operation of these modules is illustrated by the data processing stages shown in FIG. 3, and by the operations of the method 400 shown in FIG. 4, including the sub-operations of operation 416A shown in FIG. 5. Accordingly, the following description will refer as appropriate to elements shown in each of FIG. 2, FIG. 3, FIG. 4, and FIG. 5.

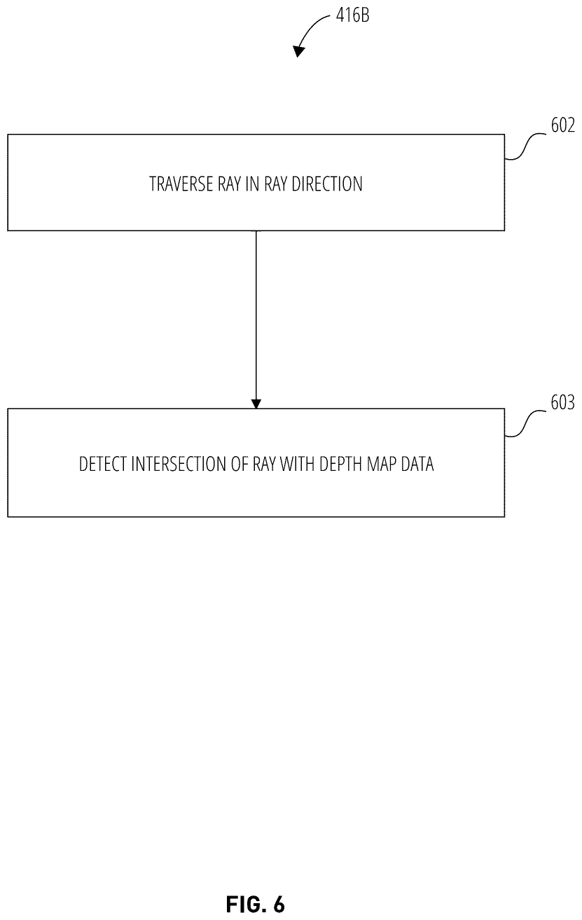

In some examples, the voxel module 212 can be omitted from the ray intersection system 104 shown in FIG. 2, and ray-world intersection can be determined without the use of a voxel representation 226 of the depth map data 232 as shown in FIG. 2 and FIG. 3. Such an example is described below with reference to operation 416B illustrated in FIG. 6.

Although the example method 400 in FIG. 4, and the operations 416A and 416B in FIG. 5 and FIG. 6 respectively, are depicted as a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

Returning to FIG. 2, the video capture module 202 is configured to generate or otherwise obtain video data 218, such one or more temporal sequences of video frames generated as or based on output from the at least one camera 108, at operation 402 of method 400. Examples described herein describe operations performed on a single video frame captured by a single camera, but it will be appreciated that in some examples the ray-world intersection operations and/or the ancillary operations used to generate the data inputs to the ray-world intersection operations (such as VIO data 220 and hand tracking data 222) can use image or video data 218 generated by more than one camera.

In some examples, the video capture module 202 retrieves images from the at least one camera 108. The images (also referred to herein as video frames) captured by the camera 108 may be retrieved continuously in real time and processed to perform the functions of the additional modules described below. These images are included in the video data 218. Each image can be of any suitable format, such as a three-color (e.g., RGB) image having three color channels, or a monochrome image having a single color channel. Each image can be of any suitable size, such as a 2D array of pixels organized into rows and columns encompassing any suitable number of pixels, such as 0.1 to 16 megapixels.

In some examples, the video capture module 202 includes or is supplemented by modules capturing additional environmental data, such as depth data captured by one or more depth sensors. However, as described above, there may be benefits to using only the output of the camera 108 to perform the ray-world intersection operations described herein, such as eliminating the need for additional sensors and/or reducing the computational complexity of the ray-world intersection operations.

The VIO module 204 generates or otherwise obtains visual inertial odometry (VIO) data 220, using existing VIO techniques, at operation 406 of method 400. In some examples, the VIO data 220 is generated based on the output of the at least one camera 108 as well as output of the IMU 110 captured at operation 404 of method 400. The VIO data 220 can include pose data, which indicates the position of the XR device 100 (e.g., the position of the camera 108) relative to points visible within the environment. The VIO data 220 includes depth values for a number of points (e.g., pixel locations) visible within a video frame captured by the camera 108 and video capture module 202. The VIO module 204 combines device position and/or movement data generated by the IMU 110 with video data 218 captured by the video capture module 202 to generate depth values for objects visible at a subset of pixel locations within the video frame. Because the VIO data 220 includes depth values for only a subset of the pixels of the video frame that is smaller than the entire set of pixels (e.g., only 50 pixels corresponding to vertices or other key points in a scene out of a million-pixel image), the VIO data 220 can be considered to comprise sparse depth data.

The hand tracking module 206 generates or otherwise obtains hand tracking data 222 based on output of the at least one camera 108 and/or one or more additional sensors, such as depth sensors, using existing hand tracking techniques, at operation 408 of method 400. The hand tracking module 206 uses the output of the at least one camera 108, captured by the video capture module 202, to generate depth values for one or more points on one or more hands visible within the video frame. For example, the hand tracking module 206 can apply machine vision techniques to the output of one or more infrared cameras mounted on the XR device 100 to recognize key points (such as joints) of the fingers, wrists, and/or palms of the user's hands when they are visible within the infrared cameras'fields of view. The camera output can then be further processed to estimate a depth for each of the tracked key points. Because these depth values apply only to a subset of the pixels of the video frame that is smaller than the entire set of pixels (e.g., only 24 pixels corresponding to joints of the hands out of a million-pixel image), like the VIO data 220, the hand tracking data 222 can be considered to comprise sparse depth data.

The depth map module 208 processes the video data 218, as well as the sparse depth data (e.g., the VIO data 220 and/or hand tracking data 222), to generate depth map data 232, including a depth map providing depth values for each pixel of the video frame, at operation 410 of method 400. In some examples, the video data 218 and sparse depth data are processed as inputs to a machine learning model 210, such as a deep neural network (as shown in FIG. 3) trained to generate depth values for pixels in an image based on sparse depth data. The machine learning model 210 can be trained using training data that includes ground truth depth maps associated with video data and sparse depth data inputs. The machine learning model 210 can be a lightweight (e.g., relatively few trained parameters) neural network that is computationally inexpensive for the depth map module 208 to apply to the video data 218 and sparse depth data in real time on a mobile device. In some examples, the lightweight model is generated through knowledge distillation or other model compression techniques prior to inclusion in the depth map module 208.

In some examples, in order to improve accuracy and eliminate unreliable depth values from the sparse depth data, the depth map module 208 omits or excludes from its processing any depth values from the VIO data 220 that fall within one or more hand regions. The hand regions are regions within the video frame that are deemed to be close to the hands (in 2D or 3D space) based on proximity to the one or more points of the hand tracking data. In some examples, the hand regions are defined by 2D bounding boxes within the 2D video frame, and any VIO depth values within these bounding boxes is excluded from processing. In some examples, the hand regions are defined based on similarity in depth values to the depth values of the hand tracking data 222, and any VIO depth values too close to the depth values of the tracked points on the hands are excluded from processing. Either of these techniques, or some combination of these and/or other hand region exclusion techniques, can be used to eliminate from the inputs to the machine learning model 210 any VIO-generated depth value that is likely to be confounded by the interposition of hands with static features of the scene visible in the video frame. Additionally, some examples may mask the hands or hand regions in the depth map data 232, in order to prevent unintentional detection of ray intersection with hands instead of static objects in the scene. In some examples, the depth map module 208 masks the hand regions (e.g., all pixels within the 2D bounding boxes, or all pixels having depth values close to those of the key points in the hand tracking data 222) to disallow the detection of intersections within this region.

In some examples, to simplify computation, the depth map data 232 is generated based on a down-sampled video frame, such that the number of depth values corresponds to a number of pixels that is reduced relative to the original video frame. In some examples, the video frame processed by the depth map module 208 is a composite or synthetic video frame generated based on two or more video frames, e.g., video frames from a pair of binocular cameras captured with the same time stamp, or multiple temporally adjacent video frames within a video steam from a single camera. Each of types of these video frames is considered to be included in the video data 218.

Thus, the depth map data 232 generated by the machine learning model 210 includes a depth map specifying, for each pixel of a plurality of pixels of the video frame, a depth value of an object visible at a pixel location of the pixel. For example, an original or down-sampled video frame showing a tabletop surface at pixel coordinate (x=422,y=156) will be processed by the machine learning model 210 (along with associated sparse depth data) to generate a depth map having a depth value (e.g., a distance in meters from the location of the camera 108) at the same pixel coordinate (x=422,y=156) that indicates the real-world depth of the corresponding point on the tabletop surface.

The operations and functional modules described above for generating the depth map data 232 are provided merely as an example of how the depth map data 232 can be generated. It will be appreciated that some examples described herein may use depth map data 232 generated or obtained by other means. For example, depth map data 232 can be generated at least in part using depth sensors (such as ultrasound or Light Detection and Ranging (LIDAR) sensors). In some examples, the depth map data 232 is obtained or generated at least in part from pre-existing depth data obtained from other sources. The ray-casting and intersection operations described below can be performed using depth map data 232 that is obtained from any suitable source or generated using any suitable techniques.

In some examples, the depth map data 232 can be processed at operation 412 of method 400 to prevent the detection of ray intersections with undesired objects in the environment. For example, some applications of ray-casting may be intended to find the intersection of a ray only with certain objects in the environment, such as static surfaces (such as floors, walls, or tabletops), and/or only with objects that are more than a predetermined distance from the XR device 100. In some cases, the user's hands are not intended to be regarded as objects in the environment that can give rise to ray intersections: for example, some applications may use the user's finger or hand as a directional pointing indicator for casting rays, such that the direction in which a user is pointing is used as the ray direction, projecting from the tip of the user's finger or another suitable location. In such cases, the ray intersection system 104 may be configured to ignore or exclude the user's hands from the image and/or the depth map when performing ray casting and intersection detection. In the illustrated example of FIG. 2, this function is performed by a hand exclusion 224 module or sub-module of the hand tracking module 206. The hand exclusion 224 module processes the depth map data 232 to exclude one or more depth values corresponding to one or more objects not intended to give rise to ray intersections: in this case, one or both of the user's hands. To accomplish this exclusion, the hand exclusion 224 module can process the hand tracking data 222 to exclude one or more depth values from the depth map data 232 based on the hand tracking data 222, for example, by excluding any depth values of the depth map data 232 that are within the hand regions as described above.

The voxel module 212 generates a voxel representation 226 of the depth map data 232, at operation 502 of operation 416A shown in FIG. 5. If the alternative example operation 416B shown in FIG. 6 is used, the voxel module 212 can be omitted.

The voxel representation 226 includes a plurality of voxels corresponding to the plurality of pixels of the depth map data 232. Each voxel can be a volumetric pixel (e.g., a cube) generated in a model of 3D space with a 3D location corresponding to the known 3D location of an object surface visible at the corresponding pixel location. The model of 3D space can then be divided into regions (e.g., larger cubes), each region encompassing zero or more voxels having local coordinates within the region. These regions, and the local coordinates assigned to each voxel within the regions, can be used to simplify the computation of collisions of rays with voxels as performed by the ray module 214 described below, using known voxel-based collision detection techniques.

In some examples, the voxels of the plurality of voxels are scaled in size based on the depth values of the corresponding pixels. For example, pixels in the depth map data 232 having depth values less than a first threshold (e.g., 0.5 meters or 1 meter) can be generated as cube voxels 1 cm to a side; pixels in the depth map data 232 having depth values between the first threshold and a second threshold (e.g., 3 meters or 5 meters) can be generated as cube voxels 5 cm to a side; and pixels in the depth map data 232 having depth values greater than the second threshold can be generated as cube voxels 10 cm to a side.

The ray module 214 obtains ray data 228 at operation 414 of method 400 and determines an intersection of at least one ray from the ray data 228 with a surface of an object visible within the video frame (using the depth map data 232 and/or its voxel representation 226) at operation 416, thereby generating intersection data 230 identifying at least the pixel location of the intersection within the video frame. The ray intersection system 104 shown in FIG. 2 performs operation 416 according to 416A shown in FIG. 5, but alternative operation 416B is described below, omitting the use of a voxel representation 226.

The ray data 228 can be obtained from a source external to the ray intersection system 104, such as another module or software application of the XR device 100. The ray data 228 is representative of at least one ray in three-dimensional space. In some examples, the ray data 228 identifies multiple rays, each of which is processed according to operation 416 to generate a respective set of intersection data 230. For example, a software application can specify four rays to cast at regularly spaced angles in order to display four virtual graphical elements within the scene. In another example, a hand tracking module can track the index fingers of one or both of the user's hands visible within the video frame and specify a ray to cast from each visible index finger in a direction corresponding to a pointing direction of the respective finger. The resulting intersection can be used to indicate a point on a surface that the user's finger is pointing toward, enabling various hand-gesture-based XR interactions. In some examples, a ray is cast downward to detect the ground or floor of the user's environment. In various examples, the ray data 228 can specify an arbitrary number of rays, with arbitrary 3D origin locations, with arbitrary directions. Each of these rays can be cast by the ray module 214 to determine a respective intersection with an object in the scene, resulting in respective intersection data 230.

Operation 416A, shown in FIG. 5, includes two sub-operations, operation 502 and operation 503. At operation 502, described above, the voxel representation 226 is generated from the depth map data 232 by the voxel module 212. At operation 503, the intersection of a ray (from the ray data 228) with the voxel representation 226 is computed, such as by using known voxel-based collision detection techniques. After a voxel is identified that corresponds to the intersection of the ray with the scene, the 2D pixel location corresponding to the voxel, as well as the depth location corresponding to the voxel, can be encoded or otherwise included in intersection data 230, thereby providing a 3D location of the intersection.

In some examples, one or more neighboring pixels (and/or their corresponding voxels) to the intersected pixel are used to determine a surface normal for the object surface at the 3D pixel location. In some examples, a filter is applied to a set of neighboring pixels (e.g., the eight pixels surrounding the intersected pixels, or all pixels within a distance of n pixels from the intersected pixel) to exclude outliers or pixels with depth values too widely divergent from the intersected pixels, to restrict the analysis to pixels that are part of the same surface and exclude pixels that are, for example, off the edge of the surface at a much different depth. The included pixels and the intersected pixel are then fitted to a local plane using a data fitting technique such as 3D linear regression to generate a flat local plane with an orientation corresponding to the 3D distribution of the included pixels and the intersected pixel. The surface normal of this plane can be included in the intersection data 230 to indicate a surface orientation of the object visible at the intersected pixel location.

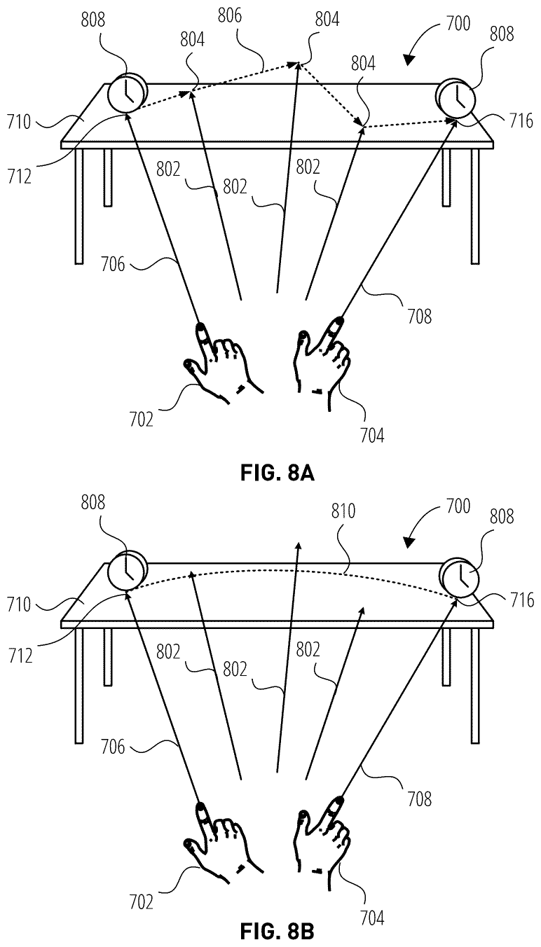

The output module 216 is used to provide the intersection data 230 to other components of the XR device 100, and/or to generate other outputs, such as visual content, for presentation on a display of the XR device 100. In some examples, the output module 216 can present virtual content to the display(s) (e.g., two near-eye displays) of an XR device 100 that is generated in accordance with the ray-casting techniques described herein. Example uses of intersection data 230 in the presentation of virtual content are described below with reference to FIG. 8A to FIG. 10.

In some examples, instead of cubic voxels, different 3D geometry is used to compute the intersection, such as 3D triangles computed based on the 3D position of each pixel and optionally one or more of its neighboring pixels.

FIG. 6, as described above, illustrates a second or alternative example of operation 416, denoted as operation 416B.

Instead of constructing a voxel representation of the depth map data 232, operation 416B relies on the depth map data 232 itself and casts the ray progressively into a 3D space model until the ray encounters a nearby 3D pixel location.

At operation 602, the ray module 214 traverses the ray in a progressive or stepwise manner. In some examples, this progressive traversal begins at the origin of the ray in 3D space. This point is checked for proximity to any 3D pixel location in the depth map data 232, for example, by applying a proximity criterion to the point being checked. The proximity criterion can be, for example, a 3D proximity threshold, or a 2D proximity threshold to filter out any pixels too far away in the 2D video frame followed by a depth proximity threshold to check the remaining pixels for depth proximity. If no pixel satisfies the proximity criterion, operation 602 proceeds to a next progressive step a predetermined sampling distance along the ray in the ray direction and repeats the proximity check. This progressive sampling or traversal of the ray continues until a pixel is found that satisfies the proximity criterion, at operation 603. This identified pixel is identified in the intersection data 230 as the intersection location of the ray with the depth map data.

In some examples, surface normal data can also be generated and included in the intersection data 230 as part of operation 416B, in the same manner described above.

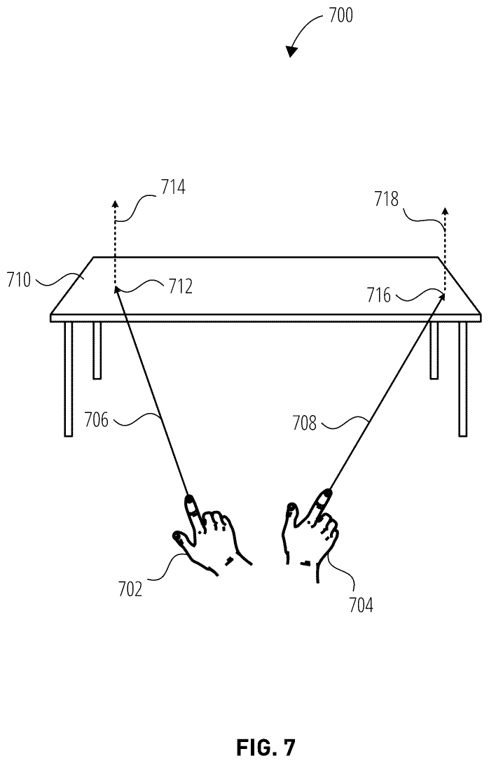

FIG. 7 illustrates an example environment 700 in which a user's finger is used as a ray casting reference to cast two successive rays into the environment 700 to generate ray-world intersection data.

In a first hand position 702, the finger of the hand is used by the ray intersection system 104 as a reference to determine the ray data 228: in this example, an origin location and a direction for the first ray 706. The first ray 706 is cast into a model of the environment 700 according to one of the techniques described above. The first ray 706 is determined to intersect with the tabletop 710 of the environment 700 at a first intersection location 712. At the first intersection location 712, the tabletop 710 is determined to have a surface orientation indicated by first intersection normal 714.

The user then moves the hand to second hand position 704. Based on hand tracking data 222 and/or video data 218, the ray intersection system 104 determines that the hand is now in second hand position 704, with the finger having a position and orientation that are used to generate new ray data 228 corresponding to second ray 708. The second ray 708 is cast into a model of the environment 700 as described above and is determined to intersect with the tabletop 710 at a second intersection location 716. At the second intersection location 716, the tabletop 710 is determined to have a surface orientation indicated by second intersection normal 718.

FIG. 8A illustrates the example environment 700 of FIG. 7 in which multiple rays are cast from the user's finger to cast multiple rays and detect multiple intersections defining a trajectory 806. After determining the first intersection location 712 and first intersection normal 714 for first ray 706, and before determining the second intersection location 716 and second intersection normal 718 for second ray 708, the user's finger moves through several intermediate poses, resulting in the casting of several intermediate rays 802, each of which is determined to intersect with the environment 700 at a corresponding intermediate intersection 804.

In the illustrated example, virtual content is presented to a user via one or more displays of the XR device 100: in this case, a virtual object 808 (shown as a virtual clock) is presented to appear as though it were resting on the tabletop 710, by rendering the virtual object 808 with a location and orientation based on the intersection location and intersection orientation. The virtual object 808 is shown on the left with a pose based on the first intersection location 712 and first intersection normal 714, and is shown on the right with a pose based on the second intersection location 716 and second intersection normal 718.

In between the first intersection location 712 and second intersection location 716, the intermediate intersections 804 define a trajectory 806. As shown in this example, the trajectory 806 is jagged and uneven, as a result of the motion of the user's finger and/or the operation of the ray intersection system 104.

FIG. 8B illustrates the example environment 700 and trajectory 806 of FIG. 8A in which the trajectory 806 has been smoothed into a smoothed trajectory 810. In some examples, the ray intersection system 104 operates to smooth the trajectory 806 to generate a smoothed trajectory 810 by applying one or more smoothing operations to the intersection data 230 for a sequence of intersections defining a trajectory 806. In some examples, the smoothing operations can include interpolation and/or filtering, such as temporal filtering. In some examples, the smoothing operations include applying a double exponential filter, similar to a moving average of the location and normal resulting from each intersection along the trajectory 806.

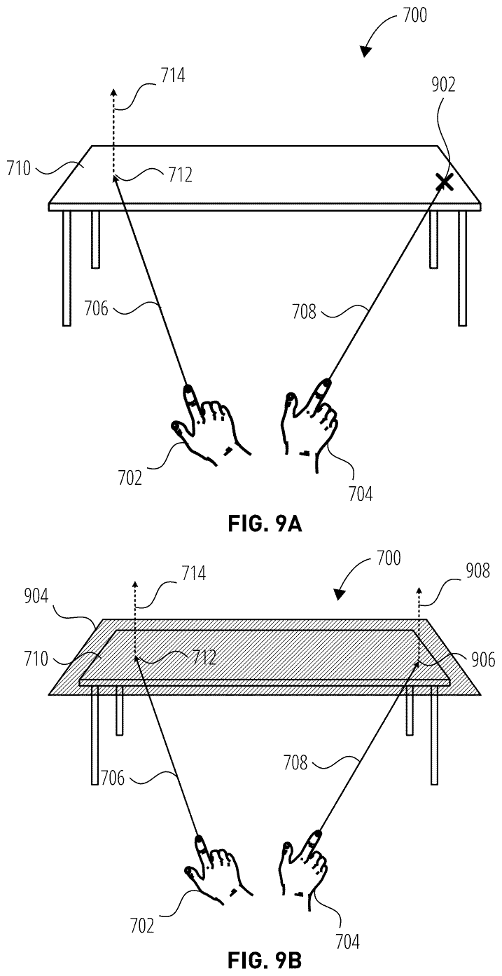

FIG. 9A shows the environment 700 of FIG. 7 to FIG. 8B, in which the second ray intersection operation has failed. In some examples, the ray intersection system 104 may not always succeed in identifying an intersection of a ray with the environment as modeled by the depth map data 232 and video data 218, as shown in FIG. 9A by failed intersection 902. These failures can give rise to problems with presenting virtual content, and can also result in interruption of the trajectory 806 if the failed intersection operation is for one of the intermediate rays 802. Accordingly, if the intersection operation fails to find an intersection, the ray intersection system 104 can fail gracefully by extrapolating a hypothetical surface from the characteristics of the intersection data 230 of a previous successfully identified intersection, as shown in FIG. 9B.

FIG. 9B shows the environment 700 of FIG. 9A in which a plane 904 is modeled by the ray intersection system 104, extended from the first intersection location 712, in order to generate second intersection data for the failed intersection 902 operation. First, the first intersection location 712 and first intersection normal 714 are processed to model a plane 904 extending from the first intersection location 712, orthogonal to the first intersection normal 714. Then, the second ray 708 is cast to determine an intersection of the second ray 708 with the plane 904, shown as a planar intersection location 906 and a planar intersection normal 908. If the first ray 706 and second ray 708 are close to each other spatially and/or temporally, the plane 904 defined by the first intersection location 712 and first intersection normal 714 can act as a reasonable proxy for the second intersection location and orientation, and can result in a smoother trajectory for the virtual content, even without the use of filtering as described above with reference to FIG. 8B.

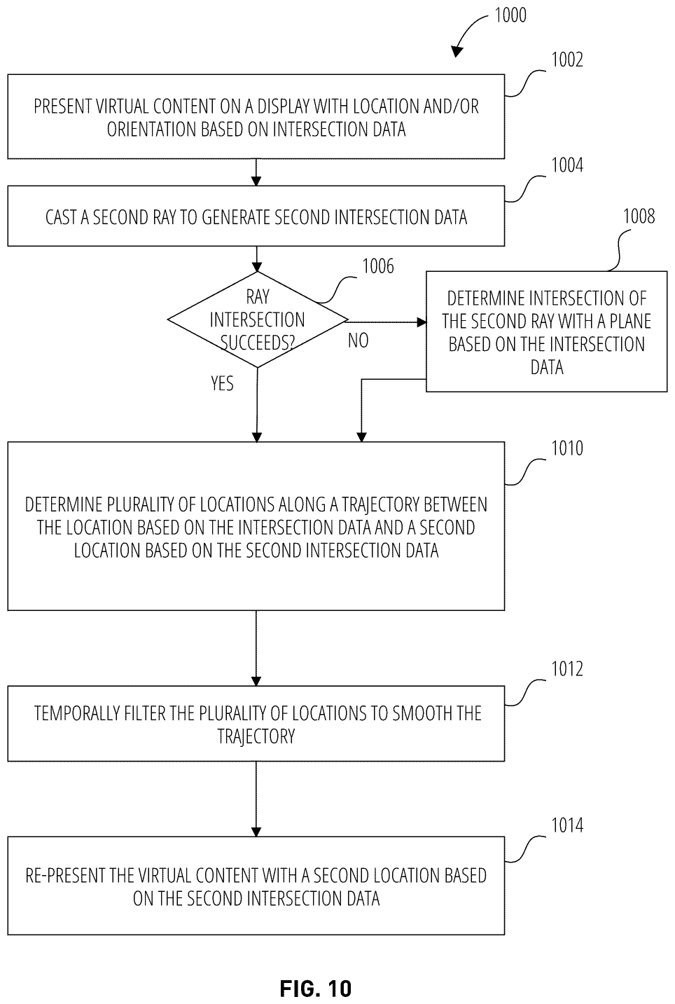

FIG. 10 is a flowchart showing operations of a method 1000 for presenting virtual content based on multiple ray-world intersections.

Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

According to some examples, the method 1000 includes presenting virtual content (e.g., virtual object 808) on a display with a location and/or an orientation based on intersection data 230 at operation 1002. For example, first ray 706 can be intersected with the environment 700 as described above, yielding intersection data 230 indicating the first intersection location 712 and first intersection normal 714. The virtual object 808 can then be presented by the output module 216 on one or more displays of the XR device 100 having a location and orientation based on the first intersection location 712 and first intersection normal 714, as shown on the left side of FIG. 8A or FIG. 8B.

According to some examples, the 1000 includes casting a second ray 708 to generate second intersection data at operation 1004. For example, as shown in FIG. 7, the second ray 708 is cast to determine its intersection with the environment 700 (in this example, the tabletop 710).

According to some examples, the method 1000 includes determining whether the ray intersection succeeds at operation 1006. If the intersection operation fails, the method 1000 proceeds to operation 1008. If the intersection operation succeeds, the method 1000 proceeds to operation 1010.

According to some examples, the method 1000 includes determining an intersection of the second ray 708 with a plane 904 based on the intersection data 230 at operation 1008. The first intersection location 712 and first intersection normal 714 of the intersection data 230 from the first ray 706 are used to model the plane 904, and an intersection of the second ray 708 and the plane 904 is determined by the ray intersection system 104. This intersection operation yields planar intersection data for the second ray 708, such as planar intersection location 906 and/or planar intersection normal 908.

According to some examples, the method 1000 includes determining a plurality of locations (e.g., first intersection location 712, the intermediate intersections 804, and second intersection location 716 or planar intersection location 906) along a trajectory 806 between the first location based on the intersection data (e.g., first intersection location 712) and the second location based on the second intersection data (e.g., second intersection location 716 or planar intersection location 906) at operation 1010. In some examples, the intermediate intersections 804 also include orientation information for each intersection.

According to some examples, the method 1000 includes temporally filtering the plurality of locations to smooth the trajectory 806 at operation 1012, thereby generating a smoothed trajectory 810. As noted above, other smoothing operations can be used in some examples.

According to some examples, the method 1000 includes re-presenting the virtual content (e.g., virtual object 808) with a second location (such as second intersection location 716 or planar intersection location 906) based on the second intersection data at operation 1014.

In some examples, the virtual content can also be presented at each of one of more of the intermediate intersections 804. The smoothing operation 1012 can help to ensure that the movement of the virtual object 808 appears natural and realistic.

### Machine Architecture

FIG. 11 is a diagrammatic representation of a machine 1100 within which instructions 1102 (e.g., software, a program, an application, an applet, an app, or other executable code) for causing the machine 1100 to perform any one or more of the methodologies discussed herein may be executed. For example, the instructions 1102 may implement all or part of the functionality of the ray intersection system 104 and cause the machine 1100 to execute any one or more of the methods described herein, such as method 400. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. In some examples, the machine 1100 may comprise both client and server systems, with certain operations of a particular method or algorithm being performed on the server-side and with certain operations of the particular method or algorithm being performed on the client-side.

The machine 1100 may include processors 1104, memory 1106, and input/output I/O components 1108, which may be configured to communicate with each other via a bus 1110. In an example, the processors 1104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1112 and a processor 1114 that execute the instructions 1102. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single-core, a single processor with multiple cores (e.g., a multi-core processor), multiple processors with a single core, multiple processors with multiples cores, or any combination thereof.

The memory 1106 includes a main memory 1116, a static memory 1118, and a storage unit 1120, both accessible to the processors 1104 via the bus 1110. The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as the display 106, a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include motion components 1128 (including the IMU 110), environmental components 1130 (including the at least one camera 108), or position components 1132 (also potentially including the IMU 110), among a wide array of other components. The motion components 1128, such as the IMU 110, can include acceleration sensor components (e.g., accelerometer), gravitation sensor components, and/or rotation sensor components (e.g., gyroscope).

The environmental components 1130 include, for example, one or more cameras (with still image/photograph and video capabilities) such as camera 108, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that may provide indications, measurements, or signals corresponding to a surrounding physical environment.

With respect to cameras, the machine 1100 may have a camera system comprising, for example, front cameras on a front surface of the machine 1100 and rear cameras on a rear surface of the machine 1100. The front cameras may, for example, be used to capture still images and video of a user of the machine 1100 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the machine 1100 may also include a 360° camera for capturing 360° photographs and videos.

Further, the camera system of the machine 1100 may include dual rear cameras (e.g., a primary camera as well as a depth-sensing camera), or even triple, quad or penta rear camera configurations on the front and rear sides of the machine 1100. These multiple cameras systems may include a wide camera, an ultra-wide camera, a telephoto camera, a macro camera, and a depth sensor, for example.

The position components 1132 include location sensor components (e.g., a GPS receiver component), altitude sensor components (e.g., altimeters or barometers that detect air pressure from which altitude may be derived), orientation sensor components (e.g., magnetometers), and the like. In some examples, the VIO module 204 and/or IMU 110 can be used as a position component to track the pose and/or position of the machine 1100 or a linked device.

Communication may be implemented using a wide variety of technologies. The I/O components 1108 further include communication components 1134 operable to couple the machine 1100 to a network 1136 or devices 1138 via respective coupling or connections. For example, the communication components 1134 may include a network interface component or another suitable device to interface with the network 1136. In further examples, the communication components 1134 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1138 may be another machine or any of a wide variety of peripheral devices (e.g., a peripheral device coupled via a USB).

Moreover, the communication components 1134 may detect identifiers or include components operable to detect identifiers. For example, the communication components 1134 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1134, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the processors 1104) and storage unit 1120 may store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 may be transmitted or received over the network 1136, using a transmission medium, via a network interface device (e.g., a network interface component included in the communication components 1134) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1138.

### Software Architecture

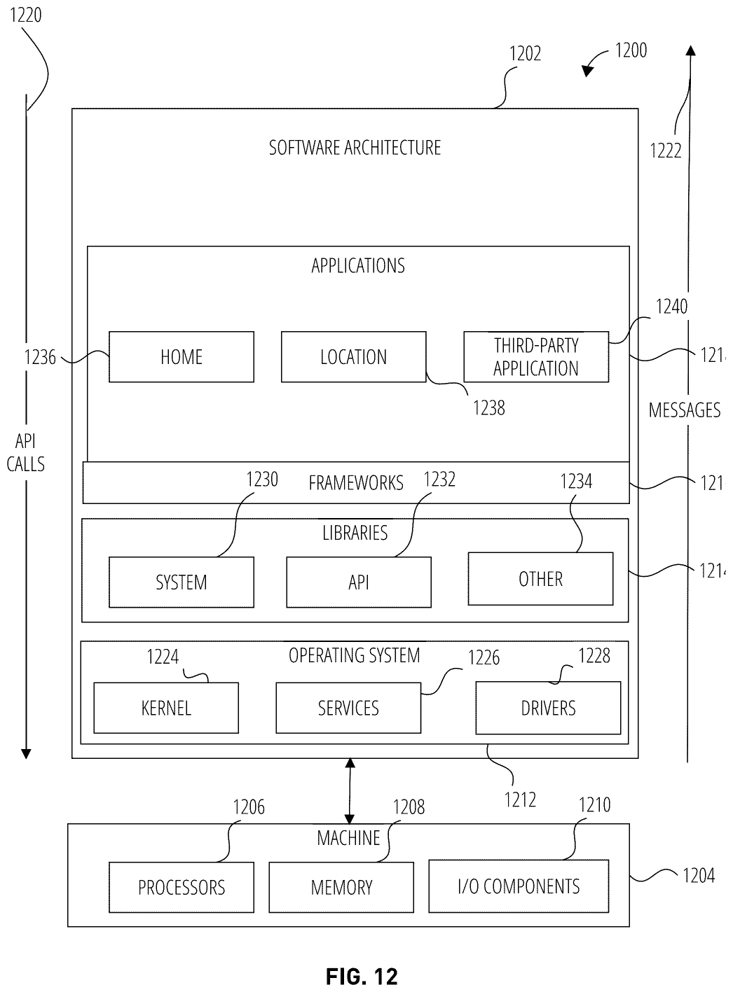

FIG. 12 is a block diagram 1200 illustrating a software architecture 1202, which can be installed on any one or more of the devices described herein. The software architecture 1202 is supported by hardware such as a machine 1204 that includes processors 1206, memory 1208, and I/O components 1210. In this example, the software architecture 1202 can be conceptualized as a stack of layers, where each layer provides a particular functionality.

The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220. The XR processing system 102 and ray intersection system 104 thereof may be implemented by components in one or more layers of the software architecture 1202.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematic functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a location application 1238, and a broad assortment of other applications such as a third-party application 1240. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1240 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1240 can invoke the API calls 1220 provided by the operating system 1212 to facilitate functionalities described herein.

### Conclusion

Examples described herein may address one or more technical problems associated with ray casting into a 3D space corresponding to a user's environment to model ray-world intersections. By leveraging existing data sources used by other components of a mobile device, such as sparse depth data sources and video data sources, ray-world intersection can be determined using computationally efficient techniques that can be executed in real time on a mobile device such as XR-enabled smart glasses. Examples described herein do not rely on binocular camera arrays or specialized depth sensors, and may be performed using a single camera. In some examples, the rays can have arbitrary 3D points of origin and arbitrary 3D directions, and multiple rays can be intersected with the scene within a single video frame. The described examples avoid the need to construct a computationally intensive 3D model such as a polygonal mesh corresponding to surfaces within the scene; instead, a computationally simple voxel representation or simply a depth map of the video frame can be used to determine the intersection.

### EXAMPLES

Example 1 is a system comprising: at least one processor; and a memory storing instructions that, when executed by the at least one processor, configure the system to perform operations comprising: obtaining video data comprising a video frame; obtaining depth map data comprising, for each pixel of a plurality of pixels of the video frame, a depth value of an object visible at a pixel location of the pixel; obtaining ray data representative of a ray in three-dimensional space; and processing the depth map data and the ray data to generate intersection data comprising a three dimensional location of an intersection of the ray with an object visible at a pixel location of a pixel of the plurality of pixels.

In Example 2, the subject matter of Example 1 includes, wherein: the operations are performed in real time for each video frame in a sequence of video frames.

In Example 3, the subject matter of Examples 1-2 includes, wherein: the processing of the depth map data and the ray data to generate the intersection data comprises: traversing the ray in a direction of the ray until the intersection is detected.

In Example 4, the subject matter of Examples 1-3 includes, wherein: the processing of the depth map data and the ray data to generate the intersection data comprises: generating a voxel representation of the depth map data; and computing the intersection of the ray with the voxel representation.

In Example 5, the subject matter of Example 4 includes, wherein: the voxel representation comprises a plurality of voxels corresponding to the plurality of pixels; and the voxels of the plurality of voxels are scaled in size based on the depth values of the corresponding pixels.

In Example 6, the subject matter of Examples 1-5 includes, wherein: the intersection data further comprises surface normal data representative of a surface orientation of the object visible at the pixel location.

In Example 7, the subject matter of Example 6 includes, wherein: the surface orientation of the object visible at the pixel location is determined by: fitting a local plane to the depth value of the pixel location and the depth values of one or more neighboring pixel locations.

In Example 8, the subject matter of Examples 1-7 includes, wherein: the ray originates from a location other than a location of a camera used to generate the video frame.

In Example 9, the subject matter of Examples 1-8 includes, a display, and the operations further comprising: presenting virtual content on the display, the presentation of the virtual content being based on the intersection data.

In Example 10, the subject matter of Example 9 includes, wherein: the virtual content is presented with a location based on the intersection data.

In Example 11, the subject matter of Example 10 includes, wherein: the virtual content is presented with an orientation based on the intersection data.

In Example 12, the subject matter of Examples 10-11 includes, wherein the operations further comprise: casting a second ray to generate second intersection data comprising a three-dimensional location of an intersection of the ray with an object visible at a second pixel location of a second pixel of the plurality of pixels; and re-presenting the virtual content with a second location based on the second intersection data.

In Example 13, the subject matter of Example 12 includes, wherein: re-presenting the virtual content with the second location comprises: presenting the virtual content at a plurality of locations along a trajectory between the location based on the intersection data and the second location based on the second intersection data.

In Example 14, the subject matter of Example 13 includes, wherein: presenting the virtual content at the plurality of locations along the trajectory comprises: temporally filtering the plurality of locations to smooth the trajectory.

In Example 15, the subject matter of Examples 12-14 includes, wherein: casting the second ray to generate the second intersection data comprises: determining an intersection of the second ray with a plane based on the location and orientation based on the intersection data.

In Example 16, the subject matter of Examples 1-15 includes, wherein: the processing of the depth map data and the ray data to generate the intersection data comprises: excluding one or more depth values corresponding to one or more objects not intended to give rise to ray intersections.

In Example 17, the subject matter of Example 16 includes, wherein: the one or more objects comprise one or more hands; and the excluding of the one or more depth values corresponding to the one or more objects comprises processing hand tracking data to exclude the one or more depth values based on the hand tracking data.

Example 18 is a method, comprising: obtaining video data comprising a video frame; obtaining depth map data comprising, for each pixel of a plurality of pixels of the video frame, a depth value of an object visible at a pixel location of the pixel; obtaining ray data representative of a ray in three-dimensional space; and processing the depth map data and the ray data to generate intersection data comprising a three dimensional location of an intersection of the ray with an object visible at a pixel location of a pixel of the plurality of pixels.

In Example 19, the subject matter of Example 18 includes, wherein: the intersection data further comprises surface normal data representative of a surface orientation of the object visible at the pixel location; and the surface orientation of the object visible at the pixel location is determined by: fitting a local plane to the depth value of the pixel location and the depth values of one or more neighboring pixel locations.

Example 20 is a non-transitory computer-readable storage medium, the computer-readable storage medium including instructions that when executed by a processor of a system, cause the system to perform operations comprising: obtaining video data comprising a video frame; obtaining depth map data comprising, for each pixel of a plurality of pixels of the video frame, a depth value of an object visible at a pixel location of the pixel; obtaining ray data representative of a ray in three-dimensional space; and processing the depth map data and the ray data to generate intersection data comprising a three dimensional location of an intersection of the ray with an object visible at a pixel location of a pixel of the plurality of pixels.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Other technical features may be readily apparent to one skilled in the art from the following figures, descriptions, and claims.

### Glossary

“Augmented reality” (AR) refers, for example, to an interactive experience of a real-world environment where physical objects that reside in the real-world are “augmented” or enhanced by computer-generated digital content (also referred to as virtual content, virtual objects, or synthetic content). AR can also refer to a system that enables a combination of real and virtual worlds, real-time interaction, and 3D registration of virtual and real objects. A user of an AR system perceives virtual content that appear to be attached or interact with a real-world physical object. The term “XR” as used herein may be understood to refer to AR unless otherwise specified.

“2D” refers to two-dimensional objects or spaces. Data may be referred to as 2D if it represents real-world or virtual objects in two-dimensional spatial terms. A 2D object can be a 2D projection or transformation of a 3D object, and a 2D space can be a projection or transformation of a 3D space into two dimensions. A 2D location may refer to a 2D set of coordinates (e.g., x-y coordinates) of a point in a 2D space such as an image.

“3D” refers to three-dimensional objects or spaces. Data may be referred to as 3D if it represents real-world or virtual objects in three-dimensional spatial terms. A 3D object can be a 3D projection or transformation of a 2D object, and a 3D space can be a projection or transformation of a 2D space into three dimensions. A 3D location may refer to a 3D set of coordinates (e.g., x-y-z coordinates) of a point in a 3D space such as the real world or a virtual space.

“Ray” refers to a ray defined by an origin point in 2D or 3D space and a direction travelled by the ray from the origin point. In the context of this disclosure, rays are defined in a 3D space unless otherwise specified.

“3D point” refers to a point defined in a data representation of a 3D space or a real-world 3D space. A 3D point, such as a 2D pixel location paired with a depth value, can also be referred to as a 3D location or a 3D pixel location.

A “position” refers to spatial characteristics of an entity such as a virtual object, a real-world object, a line, a point, a plane, a ray, a line segment, or a surface. A position can refers to a location and/or an orientation of the entity.

A first location “associated with” an object or a second location refers to the first location having a known spatial relationship to the object or second location.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A system comprising:
at least one processor; and
a memory storing instructions that, when executed by the at least one processor, configure the system to perform operations comprising:
obtaining video data comprising a video frame;
obtaining depth map data comprising, for each pixel of a plurality of pixels of the video frame, a depth value of an object visible at a pixel location of the pixel;
obtaining ray data representative of a ray in three-dimensional space; and
processing the depth map data and the ray data to generate intersection data comprising a three dimensional location of an intersection of the ray with an object visible at a pixel location of a pixel of the plurality of pixels.

2. The system of claim 1, wherein:
the operations are performed in real time for each video frame in a sequence of video frames.

3. The system of claim 1, wherein:
the processing of the depth map data and the ray data to generate the intersection data comprises:
traversing the ray in a direction of the ray until the intersection is detected.

4. The system of claim 1, wherein:
the processing of the depth map data and the ray data to generate the intersection data comprises:
generating a voxel representation of the depth map data; and
computing the intersection of the ray with the voxel representation.

5. The system of claim 4, wherein:
the voxel representation comprises a plurality of voxels corresponding to the plurality of pixels; and
the voxels of the plurality of voxels are scaled in size based on the depth values of the corresponding pixels.

6. The system of claim 1, wherein:
the intersection data further comprises surface normal data representative of a surface orientation of the object visible at the pixel location.

7. The system of claim 6, wherein:
the surface orientation of the object visible at the pixel location is determined by:
fitting a local plane to the depth value of the pixel location and the depth values of one or more neighboring pixel locations.

8. The system of claim 1, wherein:
the ray originates from a location other than a location of a camera used to generate the video frame.

9. The system of claim 1,
further comprising a display, and
the operations further comprising:
presenting virtual content on the display, the presentation of the virtual content being based on the intersection data.

10. The system of claim 9, wherein:
the virtual content is presented with a location based on the intersection data.

11. The system of claim 10, wherein:
the virtual content is presented with an orientation based on the intersection data.

12. The system of claim 10, wherein the operations further comprise:
casting a second ray to generate second intersection data comprising a three-dimensional location of an intersection of the ray with an object visible at a second pixel location of a second pixel of the plurality of pixels; and
re-presenting the virtual content with a second location based on the second intersection data.

13. The system of claim 12, wherein:
re-presenting the virtual content with the second location comprises:
presenting the virtual content at a plurality of locations along a trajectory between the location based on the intersection data and the second location based on the second intersection data.

14. The system of claim 13, wherein:
presenting the virtual content at the plurality of locations along the trajectory comprises:
temporally filtering the plurality of locations to smooth the trajectory.

15. The system of claim 12, wherein:
casting the second ray to generate the second intersection data comprises:
determining an intersection of the second ray with a plane based on the location and orientation based on the intersection data.

16. The system of claim 1, wherein:
the processing of the depth map data and the ray data to generate the intersection data comprises:
excluding one or more depth values corresponding to one or more objects not intended to give rise to ray intersections.

17. The system of claim 16, wherein:
the one or more objects comprise one or more hands; and
the excluding of the one or more depth values corresponding to the one or more objects comprises processing hand tracking data to exclude the one or more depth values based on the hand tracking data.

18. A method, comprising:
obtaining video data comprising a video frame;
obtaining depth map data comprising, for each pixel of a plurality of pixels of the video frame, a depth value of an object visible at a pixel location of the pixel;
obtaining ray data representative of a ray in three-dimensional space; and
processing the depth map data and the ray data to generate intersection data comprising a three dimensional location of an intersection of the ray with an object visible at a pixel location of a pixel of the plurality of pixels.

19. The method of claim 18, wherein:
the intersection data further comprises surface normal data representative of a surface orientation of the object visible at the pixel location; and
the surface orientation of the object visible at the pixel location is determined by:
fitting a local plane to the depth value of the pixel location and the depth values of one or more neighboring pixel locations.

20. A non-transitory computer-readable storage medium, the computer-readable storage medium including instructions that when executed by a processor of a system, cause the system to perform operations comprising:
obtaining video data comprising a video frame;
obtaining depth map data comprising, for each pixel of a plurality of pixels of the video frame, a depth value of an object visible at a pixel location of the pixel;
obtaining ray data representative of a ray in three-dimensional space; and
processing the depth map data and the ray data to generate intersection data comprising a three dimensional location of an intersection of the ray with an object visible at a pixel location of a pixel of the plurality of pixels.
